(19) United States
(12) Patent Application Publication
(10) Pub. No.: US 2002/0133557 A1
(43) Pub. Date: Sep. 19, 2002

(54) Sorting e-mail

(76) Inventor: Donna Ilene Robinson Winarski, Tucson, AZ (US)

Correspondence Address: THE WINARSKI FIRM, P.L.L.C., 1265 EAST UNIVERSITY DRIVE, SUITE 3015, TEMPE, AZ, 85281, US

(21) Appl. No.: 09/798,447

(22) Filed: Mar. 3, 2001

(51) Int. Cl. G06F 15/16

(52) U.S. Cl. 709/207; 709/206

(57) ABSTRACT

E-mail is sorted, based on whether the sender of this e-mail is known and whether the e-mail has attachments. The determination of whether the sender is known is based on the contents of the e-mail address book of the receiver. The receiver may then download the e-mail into one of four folders, or block the e-mail, based on a first predetermined choice. If the predetermined choice was to block the e-mail then the e-mail will be either held for future consideration or deleted based on a second predetermined choice.

Alternately, e-mail is sorted, based on whether the sender of this e-mail is a priority sender, a business sender, a personal sender, and whether the e-mail has attachments. The determination of whether the sender is a priority, business, or a personal sender is based on the contents of the e-mail address book of the receiver. The receiver may then download the e-mail into one of three folders. E-mail not downloaded by this alternate sort is held for future consideration.

### FIELD OF THE INVENTION

The present invention generally relates to the field of the management of electronic mail, which is commonly known as e-mail. More specifically, the present invention relates to sorting e-mail sent over the Internet, or other means of sending electronic mail, based on the identity of the sender and the contents of the receiver's address book, and whether the e-mail has attachments. One criteria for sorting the sender is based on whether the sender is merely known to the receiver, based on the contents of the receiver's address book. The e-mail is then either blocked or downloaded into folders based on whether the user is known and whether the e-mail has an attachment. If the email is blocked, it may be held for future consideration or deleted.

An alternate criteria for sorting the sender is based on whether the sender is described in the contents of the receiver's address book as a priority sender, a business sender, or a personal sender. This advanced sort is more detailed.

### BACKGROUND

The Internet has had a major impact on the productivity of modern society. However, there are times when such technology is counterproductive or even dangerous. For example, Internet users often receive destructive computer viruses in the form of email attachments. This has happened even though the attachment was supposedly an image and not an executable file. Other examples include unwanted e-mail from total strangers. Thus, there is a need to sort e-mail depending on whether the sender of the email is known and whether the e-mail has any attachments.

Sorting the e-mail, as to whether the sender of the e-mail is known and whether the e-mail has any attachments, essentially creates a matrix with four folders. The first folder is that of e-mail sent by known senders, as determined by the receiver's address book, and that e-mail has no attachments. This first folder has the safest form of e-mail to read, so it may also be called the safe folder. The second folder is that of e-mail sent by known senders, as determined by the receiver's address book, and that e-mail has attachments. Since senders known to the receiver can inadvertently pass along destructive viruses, this second folder is not the same as the first or safe folder and the receiver should exercise caution. The third folder is that of e-mail sent by unknown senders, as determined by the receiver's address book, and that e-mail has no attachments. The e-mail in this third folder would most likely not contain any destructive viruses, but the receiver would be able to scan the e-mail to look for unwanted e-mail. The fourth and final folder is that of e-mail sent by unknown senders, as determined by the receiver's address book, and that e-mail has attachments. This fourth folder would contain the e-mail that is the most dangerous to the receiver, as the sender is unknown and the attachment could be anything.

Alternately, e-mail is sorted based on whether the sender of this e-mail is a priority sender, a business sender, a personal sender, and whether the e-mail has attachments. The determination of whether the sender is a priority, business, or a personal sender is based on the contents of the e-mail address book of the receiver. The receiver may then download the e-mail into one of three folders. E-mail not downloaded by this alternate sort is held for future consideration. This alternate e-mail sorting would be valuable to business travelers who wish to be extremely selective in which e-mail they read due to time and expense constraints. E-mail clutter is reduced or eliminated and the receiver can focus on the important e-mail.

### SUMMARY OF THE INVENTION

The object of the present invention is the process of sorting incoming e-mail. Via such a process, the incoming e-mail is sorted based on the identity of the sender of the email and whether the e-mail has any attachments. One embodiment is to sort the incoming e-mail based on whether the sender is known to the receiver, based on the contents of the receiver's address book, and whether the e-mail has any attachments. Via an alternate embodiment, the e-mail is sorted, based on whether the sender of this e-mail is a priority sender, a business sender, a personal sender, and whether the e-mail has attachments.

The primary object of the invention is to sort e-mail sent over the Internet, or other means of sending electronic mail, based on the identity of the sender and the contents of the receiver's address book, and whether the e-mail has attachments.

A further object of the invention is sorting on the sender, based on whether the sender is merely known to the receiver, based on the contents of the receiver's address book. The e-mail is then either blocked or downloaded into folders based on whether the user is known and whether the e-mail has an attachment. If the e-mail is blocked, it may be held for future consideration or deleted. Each of these options of deleting the blocked e-mail or to delay downloading the blocked e-mail is available by folder.

A still further object of the invention is an advanced sort on the sender, based on whether the sender of the e-mail is a priority sender, a business sender, or a personal sender, which is determined by the contents of the receiver's address book. This advanced sort is more detailed and refined than on a sort on the sender which is based merely on whether the sender is known to the receiver.

In one embodiment, the invention is implemented to provide a method for a sorting and displaying incoming e-mail. In another embodiment, the invention is implemented to provide a signal-bearing medium tangibly embodying a program of machine-readable instructions executable by a data processing apparatus for sorting and displaying incoming e-mail. Finally, another embodiment consists of logic circuitry having a plurality of interconnected, electrically or optically conductive elements configured for sorting and displaying incoming e-mail.

Further objects and advantages of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings wherein:

FIG. 1 shows a prior art front-of-screen of incoming e-mail, as is practiced today;

FIG. 2 shows the contents of an address book;

FIG. 3 shows a flowchart for determining and sorting whether the sender of e-mail is known or unknown and whether the e-mail has an attachment;

FIG. 4 shows a front-of-screen for displaying the sorted e-mail;

FIG. 5 shows a block diagram of a computer device such as a laptop, palmtop, or game, which has a computer chip which sorts e-mail received by a wireless communications device;

FIG. 6 shows a block diagram of a computer device such as a laptop, palmtop, or game, which sorts e-mail received by a modem;

FIG. 7 shows an information bearing semiconductor chip for the microcode used in the sorting of e-mail;

FIG. 8 shows an information-bearing cartridge;

FIG. 9 shows an information-bearing storage medium for the microcode used in the sorting of e-mail;

FIG. 10 shows a front-of-screen for the selection of which types of e-mail to block and whether to hold or delete the blocked e-mail;

FIG. 11 shows a front-of-screen for the selection of the advanced sorting of e-mail;

FIG. 12 shows a flowchart for the advanced sorting of e-mail; and

FIG. 13 shows a front-of-screen for the displaying of the advanced sorted email.

### DESCRIPTION OF THE PREFERRED EMBODIMENTS

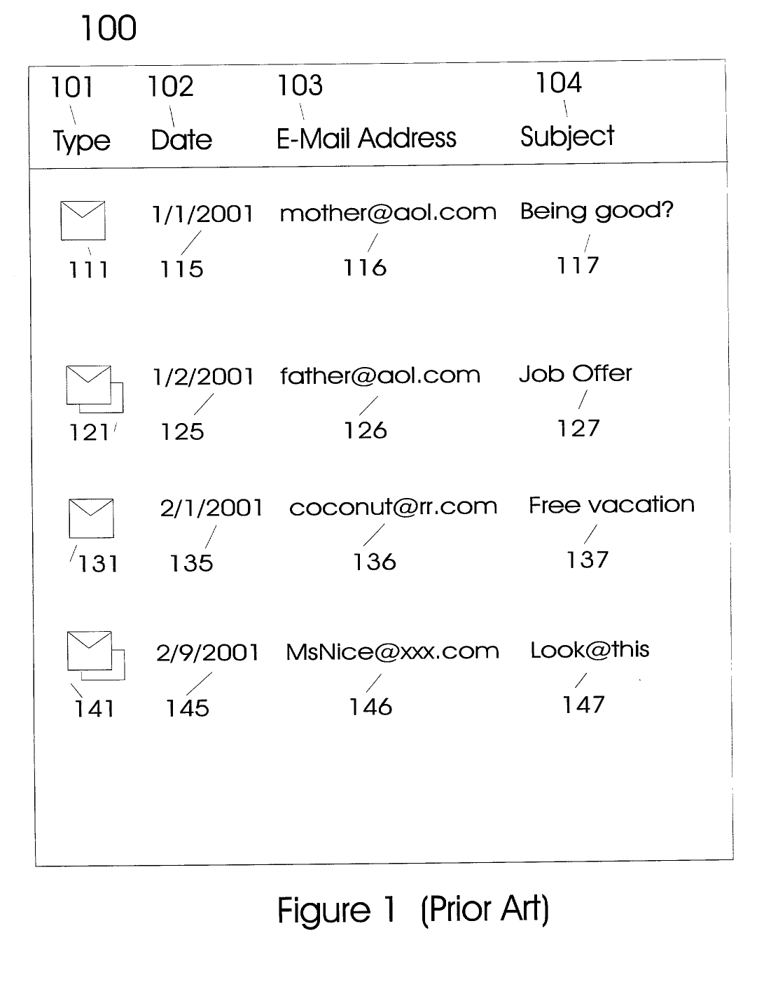

FIG. 1 shows a listing 100 of incoming e-mail, as practiced today. Listing 100 typically has helpful columns such as type of e-mail 101, date e-mail was received 102, the e-mail address of the sender 103, and the subject line of the e-mail 104.

Four example e-mails are shown in prior art e-mail front-of-screen 100 in FIG. 1. The first e-mail does not have an attachment as shown by envelope 111, was sent on Jan. 1, 2001 as shown by 115, was sent by mother @ aol.com as shown 116, and the subject is “Being good?” as shown by 117. The second e-mail does have an attachment as shown by envelope with enclosure 121, was sent on Jan. 2, 2001 as shown by 125, was sent by father @ aol.com as shown 126, and the subject is “Job offer” as shown by 127. The third e-mail does not have an attachment as shown by envelope 131, was sent on Feb. 1, 2001 as shown by 135, was sent by coconut @ rr.com as shown 136, and the subject is “Free Vacation” as shown by 137. The fourth and final e-mail does have an attachment as shown by envelope with enclosure 141, was sent on Feb. 9, 2001 as shown by 145, was sent by MsNice @ xxx.com as shown 146, and the subject is “Look@this” as shown by 147. These four example e-mails are currently unsorted and will be used to show the subject invention.

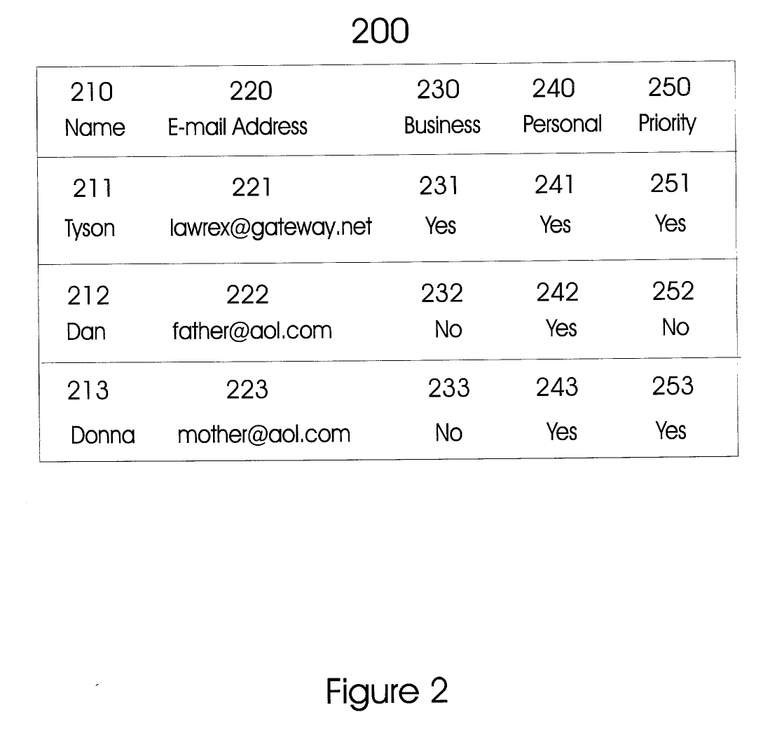

FIG. 2 shows an address book 200. Address book 200 typically has helpful columns such as Name 210, E-mail address 220, whether the sender is a business contact 230, personal contact 240, or priority contact 250. In FIG. 2 are three senders known to the receiver, based on their being listed in address book 200. The first known sender is Tyson as shown in 211, Tyson's e-mail address is lawrex @ gateway.net as shown in 221, and Tyson is a business contact 231, a personal contact 241, and a priority contact 251. The second known sender is Dan as shown in 212, Dan's e-mail address is father @ aol.com as shown in 222, and Dan is not a business contact 232, not a priority contact 252, but he is a personal contact 242. The third known sender is Donna as shown in 213, Donna's e-mail address is mother @ aol.com as shown in 223, and Donna is not a business contact 233. However, Donna is a personal contact 243 and a priority contact 253. Address book 200 can have many additional addresses of individuals, groups, charitable organizations, schools, clubs, professional societies, corporations, and the like. The receiver maintains his or her address book 200 and may add, edit, or delete entries as desired. This address book may be password protected.

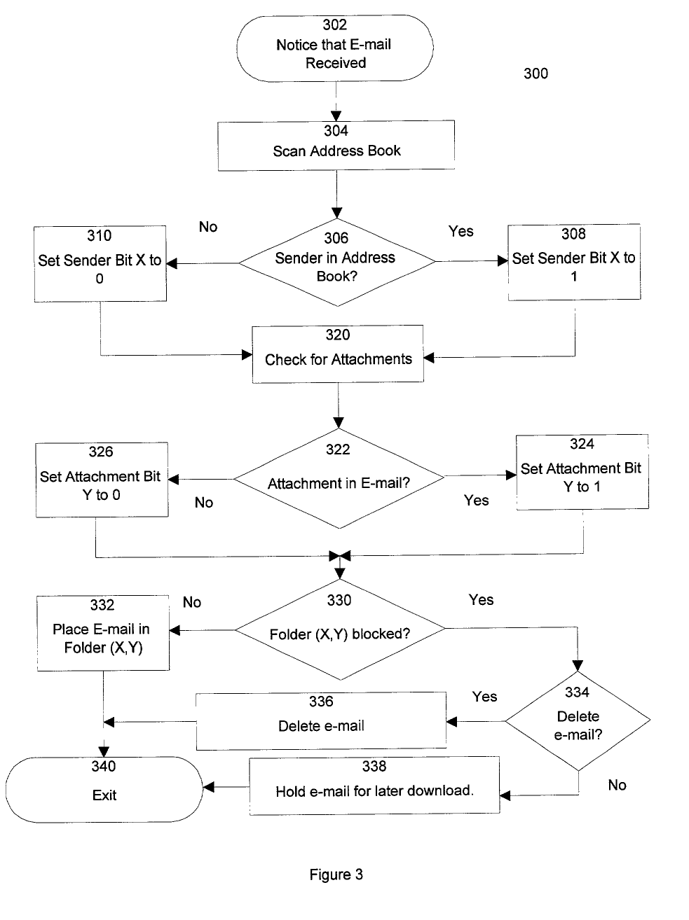

FIG. 3 shows process 300 for the sorting of incoming e-mail. In step 302, the notice that an e-mail is received is shown in step 302, which begins the e-mail sort process. The process flows from step 302 to step 304 where process 300 scans address book 200, looking for the sender of the e-mail. The process flows from step 304 to step 306 where the determination of whether the sender of the e-mail is in address book 200. If the sender of the e-mail was in address book 200, as determined by step 306, the process flows from step 306 to step 308, where the sender bit X is set to 1. Sender bit X=1 denotes that the sender has been recognized as known to the receiver, based on the contents of address book 200. The process then flows from step 308 to step 320, where process 300 checks the e-mail for an attachment. If in step 306, the sender is not in address book 200, the process flows from step 306 to step 310, where the sender bit X is set to 0. Sender bit X=0 denotes that the sender has not been recognized as known to the receiver, based on the contents of address book 200. The process then flows from step 310 to step 320, where process 300 checks the e-mail for an attachment.

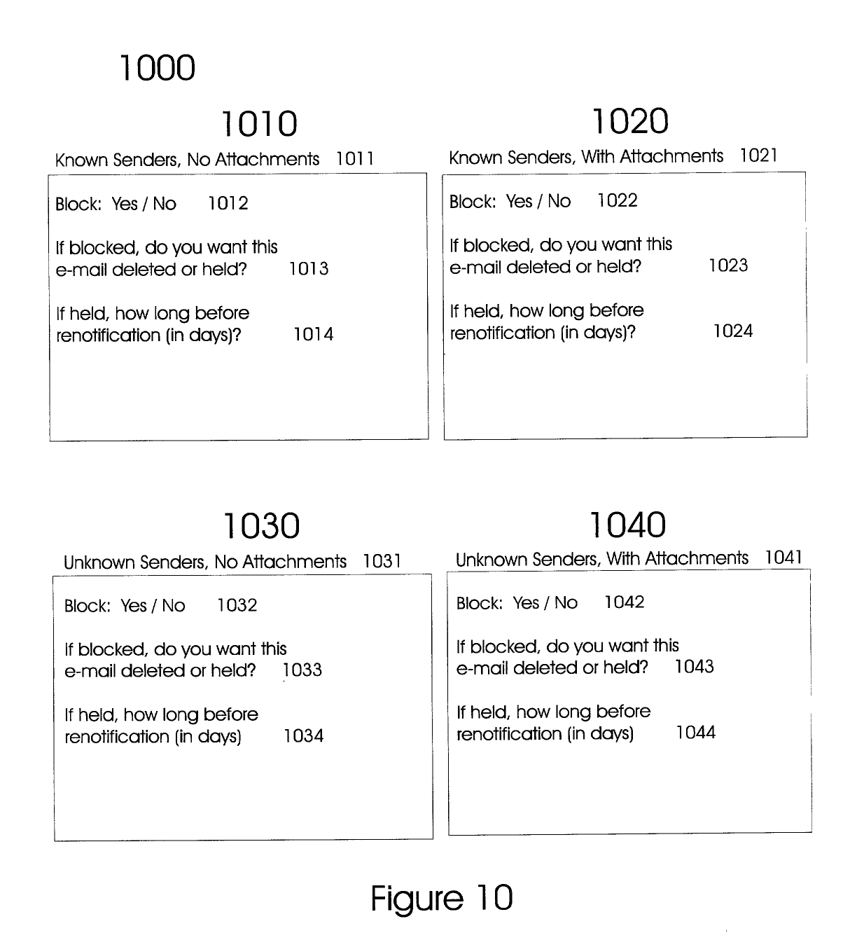

From step 320, the process flows to step 322, where a determination is made as to whether the e-mail has an attachment. If the e-mail has an attachment, as determined by step 322, the attachment bit Y is set to 1 in step 324. Attachment bit Y=1 denotes that the e-mail has been recognized as containing an attachment. Step 324 then proceeds to step 330 to see if folder (X,Y) is blocked. However, if in step 322, the e-mail does not have an attachment, the attachment bit Y is set to 0 in step 326. Attachment bit Y=0 denotes that the e-mail has been recognized as not containing an attachment. Step 326 then proceeds to step 330 to see if folder (X,Y) is blocked, based on the information given by the receiver in FIG. 10.

Having binary values for sender bit X and attachment bit Y results in a 2-by-2 matrix of four folders for sorted e-mail. Folder (1,0) denotes that the sender is known to the receiver (X=1) and that there are no attachments (Y=0). Folder (1,1) denotes that the sender is known to the receiver (X=1) and that there are one or more attachments (Y=1). Similarly, folder (0,0) denotes that the sender is unknown to the receiver (X=0) and that there are no attachments (Y=0). Finally, folder (0,1) denotes that the sender is unknown to the receiver (X=0) and that there are one or more attachments (Y=1).

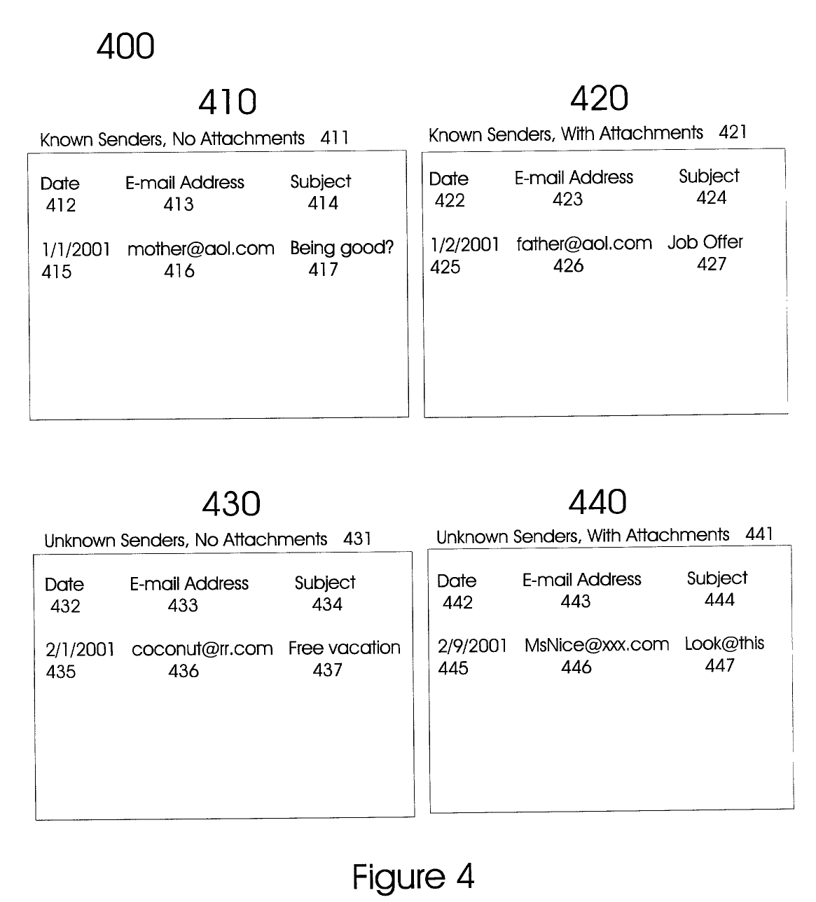

If in step 330, folder (X,Y) is not blocked, the process flows to step 332, where the e-mail is downloaded from the Internet and placed in folder (X,Y) for display as shown in FIG. 4. However, if in step 330, folder (X,Y) is blocked, the process flows to step 334, where a determination is made whether to delete the blocked e-mail, based on the input given in FIG. 10. If the e-mail is to be deleted in step 334, the e-mail is deleted in step 336 and the process flows to exit 340. However, if the e-mail is not to be deleted in step 334, the process flows to step 338 where the e-mail may be held for a time by the Internet server like America Online (AOL) for a period of time, such as a day, before a new notice for that the e-mail is issued to the intended receiver. Then, the process flows from step 338 to exit 340.

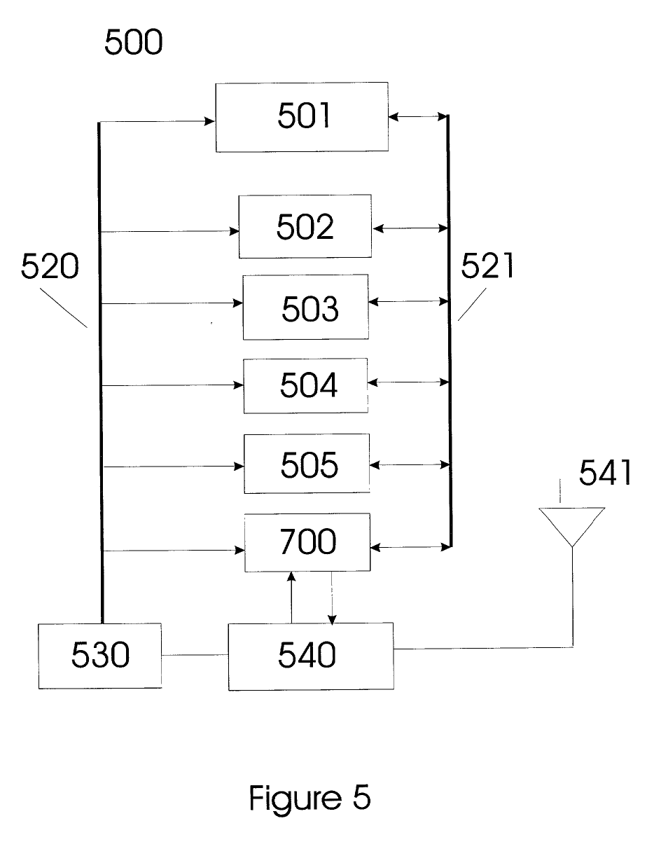

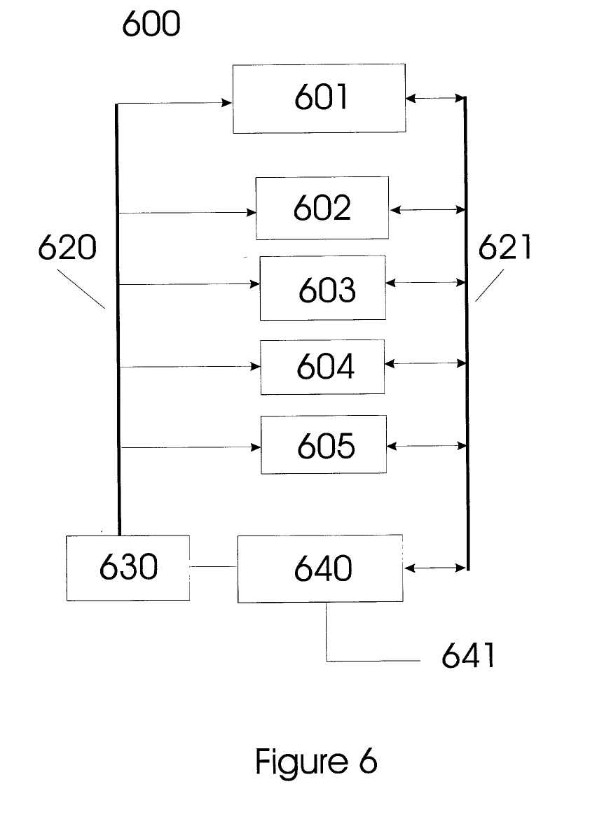

The result of the sorting of the incoming e-mail by process 300 is shown in FIG. 4. On display 503 of FIG. 5 or display 603 of FIG. 6, front-of-screen 400 shows the four folders 410, 420, 430, and 440. Folder 410 is entitled “Known Senders, No Attachments” 411. Folder 420 is entitled “Known Senders, With Attachments” 421. Folder 430 is entitled “Unknown Senders, No Attachments” 431. Finally, folder 440 is entitled “Unknown Senders, With Attachments” 441. FIG. 4 shows how the e-mail shown in FIG. 1 is sorted by process 300.

Folder 410 typically has useful columns such as date the e-mail was received 412, e-mail address of sender 413, and subject of the e-mail 414. Shown in folder 410 is an email dated Jan. 1, 2001, 415; sent by mother @ aol.com, 416; and the subject is “Being good?”, 417. Folder 420 similarly has useful columns such as date the e-mail was received 422, e-mail address of sender 423, and subject of the e-mail 424. Shown in folder 420 is an e-mail dated Jan. 2, 2001, 425; sent by father @ aol.com, 426; and the subject is “Job Offer”, 427. Folder 430 similarly has useful columns such as date the email was received 432, e-mail address of sender 433, and subject of the e-mail 434. Shown in folder 430 is an e-mail dated Feb. 1, 2001, 435; sent by coconut @ rr.com, 436; and the subject is “Free Vacation”, 437. Finally, folder 440 similarly has useful columns such as date the e-mail was received 442, e-mail address of sender 443, and subject of the e-mail 444. Shown in folder 440 is an e-mail dated Feb. 9, 2001, 435; sent by MsNice @ xxx.com, 446; and the subject is “Look@this”, 447.

From FIG. 4, the receiver can easily see what mail is being sent by whom. The e-mail in the upper left folder, folder 410 is from known senders without attachments. Folder 410 is the safe folder of the 2-by-2 matrix used to sort the e-mail. The e-mail in the upper right folder 420 is from known senders with attachments. The e-mail in the s lower left folder 430 is from unknown senders without attachments. Finally, the e-mail in the lower right folder 440 is from unknown senders with attachments. The contents of folder 440 are generally the most risky for the receiver, as the sender and the contents of the attachment are both unknown.

FIG. 5 shows computer 500. Computer 500 may be a personal computer (PC), desktop computer, laptop computer, or palmtop. Computer 500 has microprocessor 501 and memory 502. Memory 502 may be random access memory (RAM) or erasable programmable read only memory (EPROM). Computer 500 typically has a display 503. Display 503 may be a liquid crystal device (LCD). An LCD display uses organic fluids called liquid crystals, because liquid crystals possess two important properties. First, liquid crystals are transparent but can alter the orientation of polarized light passing through them. Second, the alignment of liquid crystal molecules and their polarization properties can be changed by applying an electric field. Liquid crystals are sandwiched between two glass plates, the outsides of which having been coated with polarizing filters and the inner plate is typically backlit via fluorescent light. Inside these glass plates is a matrix of electrodes. When an element of the matrix, called a pixel, experiences a voltage change, the polarization of the adjacent liquid crystal molecules change, which alters the light transmitted through the LCD pixel and hence seen by the user. However, display 503 could also be a LED (light emitting diode) display or an electroluminescent display. Although typically an output device, display 503 may be a touch-screen and thus capable of providing input to computer 500.

Additionally, computer 500 may have a dedicated input device 504 such as a keyboard or a mouse, as well as an I/O device 505, such as a floppy disk drive, a CD-ROM drive, or a DVD drive.

Computer 500 also has wireless communications chip 540, which has its own antenna 541 for wireless communication with the Internet or other e-mail carrier. Wireless communications fall under a variety of different standards. Europe and Asia currently use the GSM (Global Standard for Mobile communications) standard. Europe and Asia may switch in the future to W-CDMA (Wideband Code Division Multiple Access). In North America, CDMA (Code Division Multiple Access) networks may also migrate to W-CDMA. TDMA (Time Division Multiple Access) systems may migrate to EDGE (Enhanced Data rates for Global Evolution).

Via power bus 520, power supply 530 supplies electrical power to microprocessor 501, memory 502, display 503, dedicated input device 504, I/O device 505, as well as to wireless communications chip 540 and control chip 700.

Computer 500 also has data bus 521, which allows bidirectional communications between microprocessor 501 and memory 502, display 503, dedicated input device 504, I/O device 505, and control chip 700. Thus, when wireless communications chip 540 receives notification of an e-mail such as in step 302 of FIG. 3, control chip 700 can execute process 300 of FIG. 3. Alternately, microprocessor 501 could execute process 300 from instructions read from disk 900 by I/O device 505 and stored in memory 502.

FIG. 6 shows computer 600. Computer 600 may be a personal computer (PC), desktop computer, laptop computer, or palmtop. Computer 600 has microprocessor 601 and memory 602. Memory 602 may be random access memory (RAM) or erasable programmable read only memory (EPROM). Computer 600 typically has a display 603. Display 603 may be a liquid crystal device (LCD). However, display 603 could also be a LED (light emitting diode) display or an electroluminescent display. Although typically an output device, display 603 may be a touch-screen and thus capable of providing input to computer 600.

Additionally, computer 600 may have a dedicated input device 604 such as a keyboard or a mouse, as well as an I/O device 605, such as a floppy disk drive, a CD-ROM drive, or a DVD drive.

Computer 600 also has modem 640, which is connected to phone line 641 for communication with the Internet or other e-mail carrier. Via power bus 620, power supply 630 supplies electrical power to microprocessor 601, memory 602, display 603, dedicated input device 604, I/O device 605, as well as to modem 640.

Computer 600 also has data bus 621, which allows bidirectional communications between microprocessor 601 and memory 602, display 603, dedicated input device 604, I/O device 605, and modem 640. Thus, when modem 640 receives notification of an e-mail such as in step 302 of FIG. 3, microprocessor 601 executes process 300 from instructions read from disk 900 by I/O device 505 and stored in memory 502. Alternately, the necessary instructions to execute process 300 may be placed in memory 502 at the time computer 600 is manufactured, if memory 502 is an EPROM (Erasable, Programmable Read-Only Memory), ROM (Read-Only Memory), or NVRAM (Nonvolatile Random Access Memory).

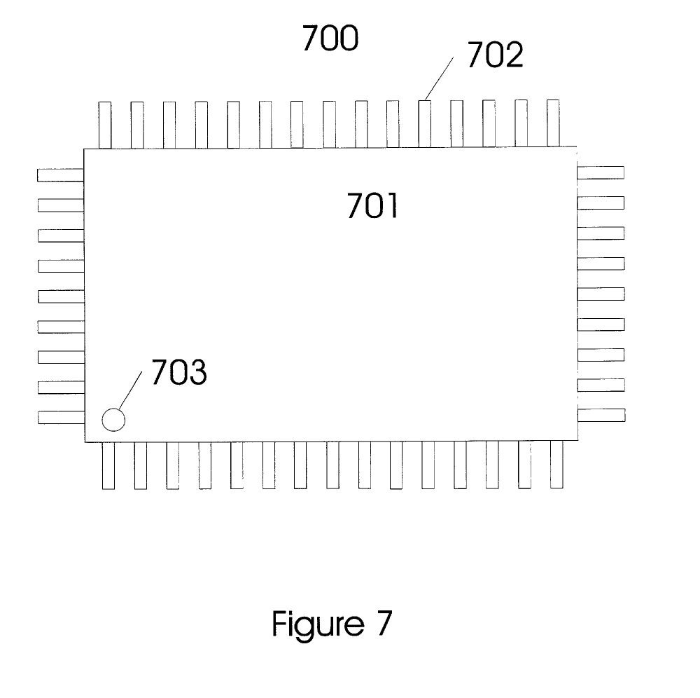

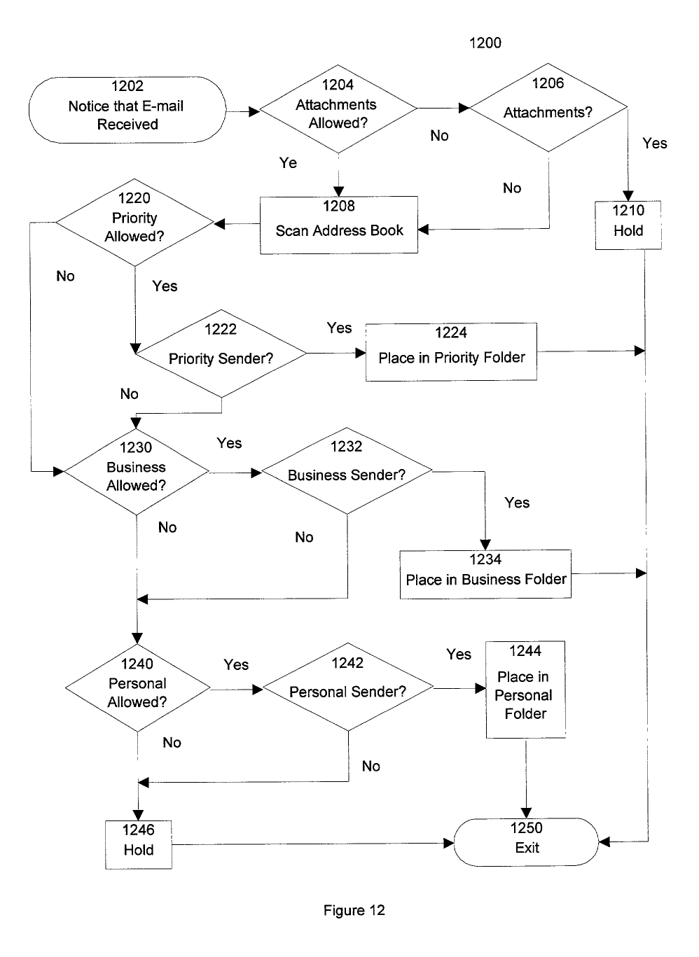

FIG. 7 shows control chip 700 which would contain the algorithms in FIGS. 3 and 12, as well as all necessary related microcode instructions for displaying FIGS. 4, 10, 11, and 13. Control chip 700 may be a RAM, an NVRAM, an EPROM, or an ASIC chip, etc. The exterior of chip 700 shows a typically square or rectangular body 701 with a plurality of electrical connectors 702 along the perimeter of body 701. There is typically an alignment dot 703 at one corner of chip 700 to assist with the proper alignment of chip 700 on a card. Within body 701, chip 700 consists of a number of interconnected electrical elements, such as transistors, resistors, and diodes. These interconnected electrical elements are fabricated on a single chip of silicon crystal, or other semiconductor material such as gallium arsenide (GaAs) or nitrided silicon, by use of photolithography. One complete layering-sequence in the photolithography process is to deposit a layer of material on the chip, coat it with photoresist, etch away the photoresist where the deposited material is not desired, remove the undesirable deposited material which is no longer protected by the photoresist, and then remove the photoresist where the deposited material is desired. By many such photolithography layering-sequences, very-large-scale integration (VLSI) can result in tens of thousands of electrical elements on a single chip. Ultra-large-scale integration (ULSI) can result in a hundred thousand electrical elements on a single chip.

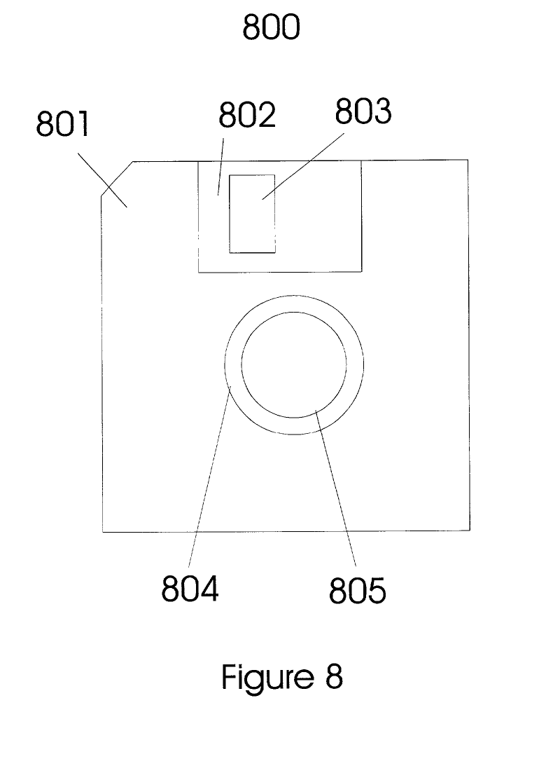

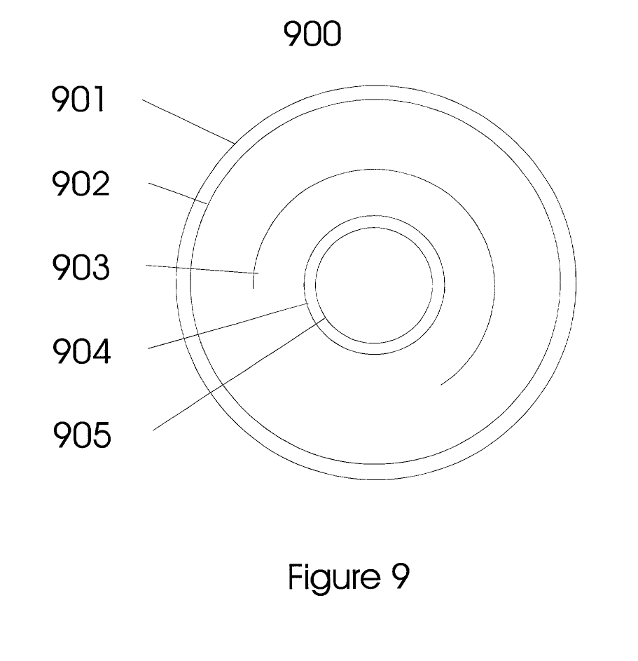

FIG. 8 shows a typical disk cartridge 800 which would contain the algorithms shown in FIGS. 3 and 12, as well as all necessary related microcode instructions for front-of-screens 400, 1000, 1100, and 1300 in FIGS. 4, 10, 11, and 13 respectively. Disk cartridge 800 consists of cartridge body 801 and shutter 802. Shutter 802 has an opening 803, so that I/O can be performed on the data on disk 900 inside of the cartridge body 801. Additional information about disk 900 is provided in FIG. 9. Cartridge body 801 has an opening 804 so that the hub 805 of the disk 900 can be rotated by a disk drive, for the purposes of I/O. The disk 900 inside of cartridge 800 could be an optical DVD (Digital Versatile Disk), an optical CD-ROM disk, a magneto-optical disk, a hard disk such as used in lomega's Jaz drive, or a floppy disk, such as used in lomega's Zip drive.

FIG. 9 shows a typical floppy disk 900 which could be contained in disk cartridge 800, but need not be contained in cartridge 800. Disk 900 has an circular outer perimeter 901. The algorithm in FIG. 3, as well as all necessary microcode instructions to display FIGS. 4 and 10, would be recorded in circular or spiral tracks 903 between the inner data radius 904 and the outer data radius 902. Hub 905 may be used to rotate the disk 900 so that I/O can be performed on the data in tracks 903.

The user of computers 500 or 600 would use front-of-screen 1000 of FIG. 10 for issuing instructions for the management of each of the four folders 410, 420, 430, and 440. Upper left frame 1010 is titled “Known Senders, No Attachments” 1011. Within frame 1010 the user must decide to block e-mail to folder 410 via input 1012. If the user is blocking folder 410, the user must decide to delete the e-mail or to place that e-mail on hold, 1013. If the user is placing the e-mail on hold, the time period before the user is renotified of this email is specified in 1014. This time period keeps process 300 from continually reexamining the held e-mail.

Upper right frame 1020 is titled “Known Senders, With Attachments” 1021. Within frame 1020 the user must decide to block e-mail to folder 420 via input 1022. If the user is blocking folder 420, the user must decide to delete the e-mail or to place that e-mail on hold, 1023. If the user is placing the e-mail on hold, the time period before the user is renotified of this email is specified in 1024.

Lower left frame 1030 is titled “Unknown Senders, No Attachments” 1031. Within frame 1030, if the user is blocking folder 430, the user must decide to delete the e-mail or to place that e-mail on hold, 1033. If the user is placing the e-mail on hold, the time period before the user is renotified of this email is specified in 1034.

Lower right frame 1040 is titled “Unknown Senders, With Attachments” 1041. Finally, within frame 1040 the user must decide to block e-mail to folder 440 via input 1042. If the user is blocking folder 420, the user must decide to delete the e-mail or to place that e-mail on hold, 1043. If the user is placing the e-mail on hold, the time period before the user is renotified of this email is specified in 1044.

It is folder 440 which places the receiver in the greatest danger from computer viruses, so the user may wish to block and automatically delete entries to folder 440 in FIG. 10. However, the receiver may be on a business trip and would not like to download any e-mail with attachments over the Internet, in order to minimize long-distance telephone charges which might be generated by the downloading of large files over slow modems. Thus, in FIG. 10, the e-mails with attachments may be blocked but held rather than deleted. The front-of-screen 1000 in FIG. 10 may be entered from time to time by the user to change his or her preferences.

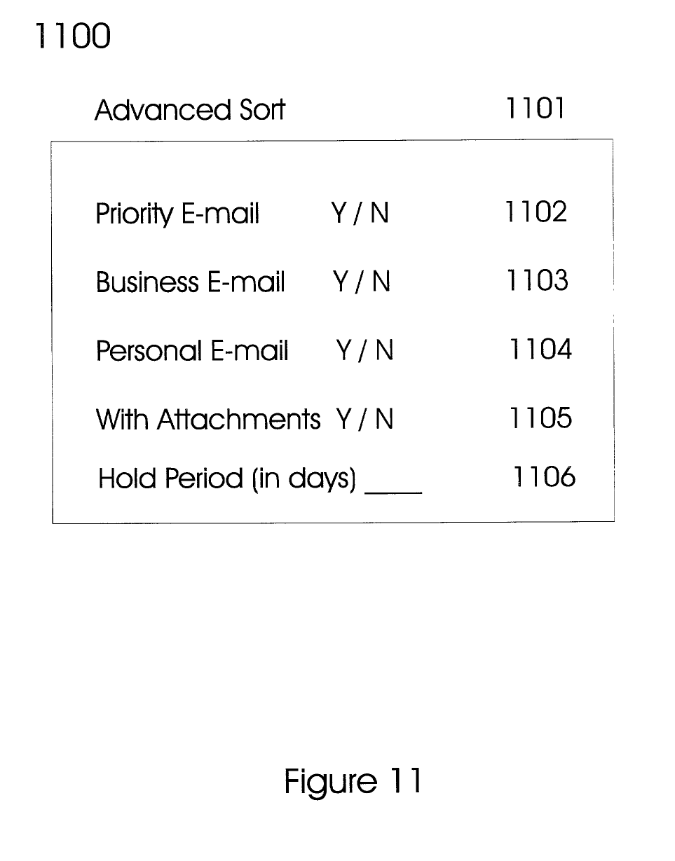

FIG. 11 shows front-of-screen 1100, which is entitled “Advanced Sort” 1101. The receiver may edit choices for the advanced sort of the sender. For example, the receiver may decide whether to receiver priority e-mail 1102, business e-mail 1103, personal e-mail 1104, and whether he or she wants e-mail with attachments 1105. Additionally, the receiver must declare the hold period of any held e-mail in days, 1106. E-mail not downloaded would be held by the server, such as AOL, for this period before renotifying the receiver of it. This way process 1200 in FIG. 12 need not be continually queried about held mail.

FIG. 12 shows process 1200 for the advanced sorting of e-mail. The process begins when a notice of e-mail is received in step 1202. Step 1202 flows to step 1204, where the determination is made whether the receiver desires any e-mail with attachments, per entries made in front-of-screen 1100. If the answer is no, the process flows from step 1204 to step 1206, where the determination is made whether the e-mail has any attachments. If the e-mail does have attachments, the process flows from step 1206 to step 1210, where the e-mail is places on a hold status for the predetermined time set in front-of-screen 1100. Then the process flows from step 1210 to exit 1250.

However, if either in step 1206 there are no attachments, or in step 1204 attachments are allowed, the process flows to step 1208, where the process scans the contents of address book 200. The process then flows to step 1220 where the determination is made whether the receiver has allowed priority e-mail in front-of-screen 1100. If the receiver has allowed priority e-mail, the process flows from step 1220 to step 1222, where the determination is made whether the sent e-mail is from a priority sender, based on the contents of address book 200. If the send e-mail is from a priority sender, the process flows from step 1222 to step 1224, where the e-mail is placed in the priority folder. Then the process flows from step 1224 to exit 1250. However, if either in step 1220 priority e-mail is not allowed or in step 1222 the sender is not a priority sender, the process flows to step 1230 where the determination is made whether the receiver has allowed business e-mail from front-of-screen 1100.

If the receiver has allowed business e-mail, the process flows from step 1230 to step 1232, where the determination is made whether the sent e-mail is from a business sender, based on the contents of address book 200. If the send e-mail is from a business sender, the process flows from step 1232 to step 1234, where the e-mail is placed in the business folder. Then the process flows from step 1234 to exit 1250. However, if either in step 1230 business e-mail is not allowed or in step 1232 the sender is not a business sender, the process flows to step 1240 where the determination is made whether the receiver has allowed personal e-mail from front-of-screen 1100.

If the receiver has allowed personal e-mail, the process flows from step 1240 to step 1242, where the determination is made whether the sent e-mail is from a personal sender, based on the contents of address book 200. If the send e-mail is from a personal sender, the process flows from step 1242 to step 1244, where the e-mail is placed in the personal folder. Then the process flows from step 1244 to exit 1250. However, if either in step 1240 personal e-mail is not allowed or in step 1242 the sender is not a personal sender, the process flows to step 1246, where the e-mail is placed on a hold status at the server, such as AOL, for the predetermined time set in front-of-screen 1100. Then the process flows from step 1246 to exit 1250. Once at exit 1250, process 1200 is ready to be restarted by the next incoming e-mail.

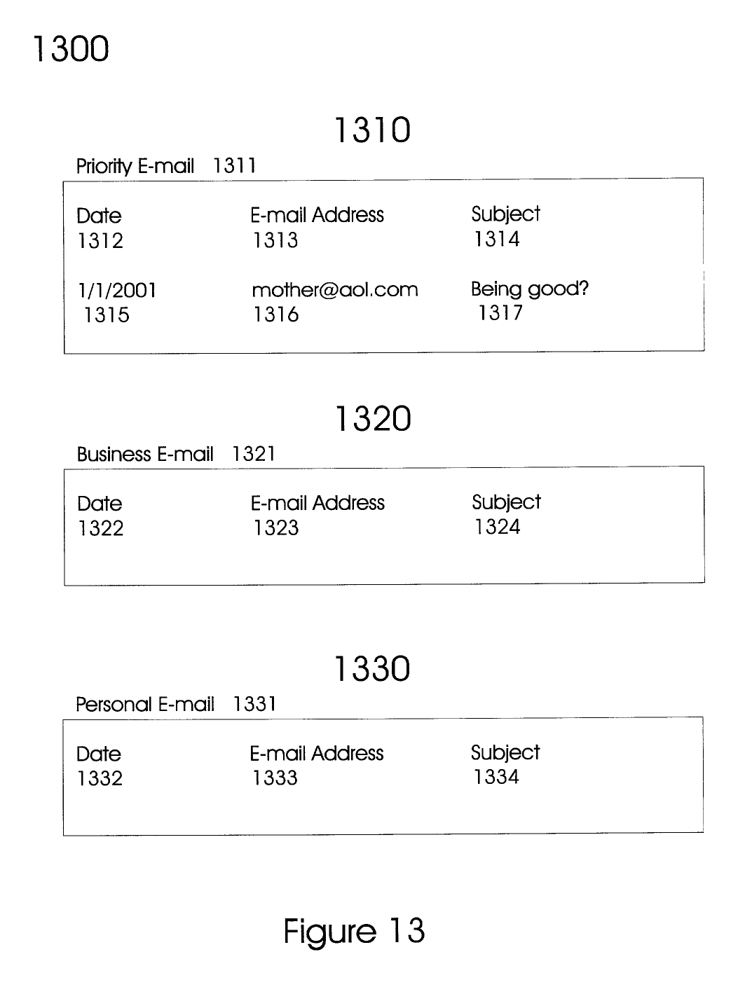

The results of process 1200 are shown in front-of-screen 1300 of FIG. 13. Front-of-screen 1300 has three folders. The first folder 1310 has title “Priority E-mail” 1311. The second folder 1320 has title “Business E-mail” 1321. The third folder 1330 has title “Personal E-mail” 1331.

Priority folder 1310 has helpful columns such as date 1312, the e-mail address of the sender 1313, and the subject of the e-mail 1314. Similarly, business folder 1320 has helpful columns such as date 1322, the e-mail address of the sender 1323, and the subject of the e-mail 1324. Finally, personal folder 1330 has helpful columns such as date 1332, the e-mail address of the sender 1333, and the subject of the e-mail 1334.

These three folders in FIG. 13 would allow the highly selective sorting of incoming e-mail, which may be advantageous to business travelers. For example, by sorting the e-mail in FIG. 1 for priority, business, and personal e-mail, but not allowing attachments, there is only one entry of e-mail in FIG. 13. Shown in folder 1310 is an email dated Jan. 1, 2001, 1315; sent by mother @ aol.com, 1316; and the subject is “Being good?”, 1317. All other e-mail is held at the server because the receiver was able to sort and receive only that e-mail deemed important by him or her.

While the invention has been shown and described with reference to a particular embodiment thereof, it will be understood to those skilled in the art, that various changes in form and details may be made therein without departing from the spirit and scope of the invention.

What I claim is:

1. A method for sorting electronic mail sent by a sender, comprising the machine executed steps of:
locating whether said sender is listed in an address book;
determining whether said electronic mail has an attachment; and
sorting said e-mail based on whether said sender is listed in said address book and whether said electronic mail has said attachment.

2. The method for sorting electronic mail, as in claim 1, further comprising the machine executed steps of:
selectively blocking said electronic mail, based on whether said sender is listed in an address book and whether said electronic mail has said attachment.

3. The method for sorting electronic mail, as in claim 2, further comprising the machine executed steps of:
deleting said blocked electronic mail without downloading it.

4. The method for sorting electronic mail, as in claim 2, further comprising the machine executed steps of:
holding said blocked electronic mail without downloading it; and
after a predetermined period of time, resorting said electronic mail.

5. A program storage device readable by a computer, tangibly embodying a program of instructions executable by said computer, to perform method steps sorting electronic mail sent by a sender, comprising the machine executed steps of:
locating whether said sender is listed in an address book;
determining whether said electronic mail has an attachment; and
sorting said e-mail based on whether said sender is listed in said address book and whether said electronic mail has said attachment.

6. The program storage device readable by a computer for sorting electronic, as in claim 5, further comprising the machine executed steps of:
selectively blocking said electronic mail, based on whether said sender is listed in an address book and whether said electronic mail has said attachment.

7. The method for sorting electronic mail sent by a sender, as in claim 6, further comprising the machine executed steps of:
deleting said blocked electronic mail without downloading it.

8. The method for sorting electronic mail sent by a sender, as in claim 7, further comprising the machine executed steps of:
holding said blocked electronic mail without downloading it; and
after a predetermined period of time, resorting said electronic mail.

9. A logic array readable by a computer, tangibly embodying a program of instructions executable by said computer, to perform method steps sorting electronic mail sent by a sender, comprising the machine executed steps of:
locating whether said sender is listed in an address book;
determining whether said electronic mail has an attachment; and
sorting said e-mail based on whether said sender is listed in said address book and whether said electronic mail has said attachment.

10. The logic array readable by a computer for sorting electronic, as in claim 9, further comprising the machine executed steps of:
selectively blocking said electronic mail, based on whether said sender is listed in an address book and whether said electronic mail has said attachment.

11. The method for sorting electronic mail sent by a sender, as in claim 10, further comprising the machine executed steps of:
deleting said blocked electronic mail without downloading it.

12. The method for sorting electronic mail sent by a sender, as in claim 10, further comprising the machine executed steps of:
holding said blocked electronic mail without downloading it; and
after a predetermined period of time, resorting said electronic mail.
